(19) United States
(12) Patent Application Publication
(10) Pub. No.: US 2026/0245376 A1
(43) Pub. Date: Aug. 20, 2026

(54) Method and Apparatus for Identifying a Parking Space for a Vehicle by Means of Machine Learning Methods

(71) Applicant: Robert Bosch GmbH, Stuttgart (DE)

(72) Inventors: Cedric Perauer, Reutlingen (DE); Joel Janai, Leonberg (DE); Muenir Kayalar, Schoenaich (DE)

(21) Appl. No.: 18/872,096

(22) PCT Filed: Jun. 6, 2023
(86) PCT No.: PCT/EP2023/065111

§ 371 Date: Dec. 5, 2024

(30) Foreign Application Priority Data
Jun. 10, 2022 (DE) 10 2022 205 910.7

(51) Int. Cl. G06V 20/58; B60W 30/06; G06V 10/774; G06V 10/82

(52) U.S. Cl. CPC G06V 20/586; B60W 30/06; G06V 10/774; G06V 10/82; B60W 2420/403

(57) ABSTRACT

A computer-implemented method, in particular a computer-implemented method for identifying a parking space for a vehicle, includes (i) providing a camera image, and (ii) evaluating the camera image using a data-based parking space identification model. The parking space identification model is designed to assign a camera image to a representation of a parking space in surroundings of the vehicle that are covered by the camera image. The representation of the parking space indicates a position for a line of entry into an identified parking space in a vehicle coordinate system.

### TECHNICAL FIELD

The invention relates to methods for identifying parking places or parking spaces for a vehicle based on object identification algorithms.

### TECHNICAL BACKGROUND

Automatically identifying a possible parking space for a vehicle is a basic requirement for downstream methods of automatically parking a vehicle.

Detecting a parking space is typically based on an evaluation of a camera image representing the surroundings of the vehicle. For example, as known from H. Do et al., “Context-Based Parking Slot Detection With a Realistic Dataset,” IEEE Access, Vol. 8, 2020, the coordinates of four vertices of a parking space may be determined by using a two-step method based on a camera image of the surroundings. In this method, there is a first step for approximate identification of an area in which a possible parking space is located, including its orientation using a first neural network, and a second step for detailed identification of a parking space within the approximate area of a possible parking space indicated by the first step. The output of the second step corresponds to the four vertices of an identified square parking space. The method improves previous identification methods, which can determine a rectangular parking space area and indicate the width, height and center coordinates.

However, the two-step design of parking space identification according to the prior art described above has the drawback that artificial neural networks that are designed with multiple steps tend to lose information obtained or not pass it on to the next step. Elaborate end-to-end training with both neural networks can mitigate this problem, but also in this case errors or inaccuracies in the first step are amplified in the second step.

Publication DE 10 2010 047 162 A1 discloses a method for identifying free parking spaces by analyzing image data captured in a vehicle with at least one image capturing device, with the steps of: capturing and storing input images of lateral surroundings of the vehicle during movement of the vehicle, determining and tracking reference points by analyzing the captured input images, reconstructing a 3D model of the lateral surroundings of the vehicle in the form of a 3D scatter plot using the reference points, and analyzing the 3D scatter plot to detect a free parking space. In order to enable a particularly simple and fast selection of a suitable free parking space, the 3D scatter plot of the lateral surroundings of the vehicle is output as an output image, wherein a dimensional 3D model of the vehicle is inserted into the output image in the position of an image of the identified free parking space.

Publication DE 11 2020 000 369 T5 discloses a method for identifying a parking space using a neural network, wherein data representing displacement values for vertices of an anchor shape is determined from image data representing a parking space using the neural network. Vertices of a distorted polygon are determined from the displacement values for vertices of the anchor shape, and a first distance between the vertices of the distorted polygon and ground truth vertices of the parking space are calculated.

### DISCLOSURE OF THE INVENTION

According to the present invention, a method is provided for identifying a parking space, in particular for a subsequent automatic parking method according to claim 1, as well as a corresponding device according to the subordinate claim.

Further embodiments are specified in the dependent claims.

According to a first aspect, a method of identifying a parking space for a vehicle is provided, having the steps of:
providing a camera image;
evaluating the camera image using a data-based parking space identification model, the parking space identification model being designed to assign a camera image to a representation of a parking space in surroundings of the vehicle that are covered by the camera image, wherein the representation of the parking space indicates a position for a line of entry into an identified parking space in a vehicle coordinate system.

For automatic parking methods, the evaluation of camera images for identifying parking spaces in the surroundings of a vehicle is essential. To this end, an object identification algorithm is typically used based on a convolutional neural network, for example in the form of a YOLOv3 method.

For parking space identification, as described above, multi-step identification methods are proposed in the prior art, which provide a first neural network for context recognition and restriction of a search area and a further neural network for actual identification of the location of the parking space. The aforementioned drawbacks in the training process of such multi-step parking space identification systems can be overcome using the above method with, firstly, a single-step neural network that directly outputs the parking space definition parameters that performs parking space identification based on the camera image data. Secondly, the parameters for defining the parking space are selected such that they represent a particularly suitable parking space representation for a subsequent automatic parking method based on them, for example.

While it is known from the prior art to identify a parking space through the four vertices of the rectangular parking area, the above method applies a parking space representation, which is characterized by defining the location of the line of entry into a parking space. Further information defining the parking space may then be based on the line of entry.

Furthermore, the location of the line of entry may be indicated as the length and orientation of a distance vector between a center of the line of entry and a line of entry angle relative to a center of a grid cell in a grid line network that overlays an object identification algorithm over the camera image. In particular, the location of the line of entry may further be indicated with a width of the line of entry.

The line of entry may be determined by distance and direction relative to a center of a grid cell, with which the area captured by the camera image is plotted and by the width of the detected line of entry.

The parking space identification model may be configured with a neural network or other data-based model suitable for image evaluation, and in particular have a YOLOv3 architecture that locates identified parking spaces in the grid line network.

It may be contemplated that the representation of the parking space may be further indicated by side boundary lines, the location and orientation of which is defined based on the location of the line of entry, in particular by a length of the respective side boundary line and the side boundary line angle to the line of entry.

The above representation of a parking space as a location result of a parking space identification model is advantageous because this representation of the parking space is directly based on the characteristics of the parking space. Thus, these characteristics of the parking space need not be determined from four vertices of the parking space, as in the example described as prior art. Therefore, an appropriate selection of the loss parameters (parameters of a cost function for training the model) for training the parking space identification model, regarding the quality of the identified values, can be optimized. For example, more precise identification of the location of the line of entry may be more important than identification of the lengths of the side boundary lines. This aspect may be taken into account accordingly by reducing the proportion that the length of the side boundary lines as compared to the total loss are considered for training the parking space identification model.

Since the aforementioned representation of a parking space can better evaluate the characteristics of the identified parking space, the loss function for training the parking space identification model can be focused more on the needs of parking space identification. In particular, by using the angles α and β between the line of entry and the two side boundary lines, parking spaces may be automatically identified that are perpendicular or oblique to the direction of travel. By identifying the center of the line of entry, parking in the parking space can be performed using an automatic parking system even if the values of the width of the line of entry and the lengths of the side boundary lines have not been identified with high precision. For example, by using object identification systems, for example, with ultrasonic sensors and the like, the free area can be measured and the parking space can be utilized using the localized line of entry, which is defined, for example, by the distance and angle to a center of a grid cell when using a YOLOv3 method.

Furthermore, the above representation of a parking space allows the elements of a parking space to be determined separately and, insofar as possible, independently of each other. Thus, the side boundary lines are each described by the angle to the line of entry and the length of the side boundary lines and are thus independent of each other. Therefore, it is possible to independently calculate confidences for the line of entry parameters, such as the distance vector between the center of the closest grid cell and the center of the line of entry, the orientation of the distance vector and the width of the line of entry, as well as the side boundary line parameters comprising the angles between the side boundary lines and the line of entry and the lengths of the side boundary lines. With these confidences, the automatic parking system can improve the parking space selection for a plurality of identified parking spaces.

According to one embodiment, representation of the parking space by an automatic parking algorithm may be used to automatically control parking of the vehicle, particularly by determining a parking trajectory.

According to a further aspect, a method for training a data-based parking place identification model is provided, having the following steps:
providing training data sets that each assign a camera image of vehicle surroundings to a representation of a parking space captured in the camera image, wherein the representation of the parking space indicates a position for a line of entry and a location and orientation of side boundary lines connected to the line of entry,
training the data-based parking space identification model using a loss function, wherein the loss function weights the location of the line of entry higher than the location and orientation.

Furthermore, the loss function may evaluate a difference between the side boundary line angles to the line of entry.

### BRIEF DESCRIPTION OF THE DRAWINGS

Preferred embodiments are described in more detail below with reference to the accompanying drawings. The figures show:

FIG. 1 shows a schematic representation of a motor vehicle with a camera system for capturing surroundings and an assistance system;

FIG. 2 shows a schematic representation of a functional diagram of a parking space identification system; and

FIG. 3 shows a schematic representation of a parking space including the variables representing the parking space.

### DESCRIPTION OF EMBODIMENTS

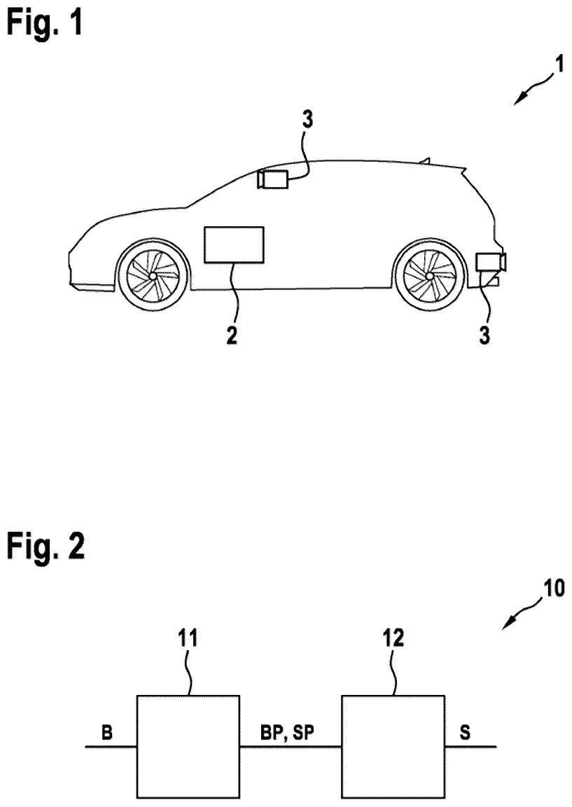

FIG. 1 shows a schematic illustration of a vehicle 1 equipped with an assistance system 2. The assistance system 2 is connected to a camera system 3 so that one or more camera images of the surroundings of the vehicle 1, in particular a part of the surroundings in the front and back directions, can be provided to the assistance system 2.

The camera images provided by the camera system 3 are evaluated in the assistance system 2 using a parking space identification model and a representation of a position of a parking space in the surroundings is determined. The parking space representation can then be used, for example, using an automatic parking algorithm that may be performed in the assistance system 2, to automatically park the vehicle 1 in the identified parking space.

FIG. 2 shows a schematic representation of an automatic parking system 10 consisting of a parking space identification model 11 and a parking algorithm 12. The parking space identification model 11 is configured in the form of a data-based model having an object identification architecture. For example, the parking space identification model 11 may be configured using a YOLOv3 network architecture. On the input side, the parking space identification model obtains a camera image B of the surroundings of the vehicle. The camera image B can in particular be a composite image from a plurality of cameras 3 and can be provided as an RGB image.

The YOLOv3 network architecture, as is well known, has multiple layers of a convolutional neural network, which map a location of a possible parking space within a grid line network that displays the surroundings of the vehicle in a horizontal direction. The grid line network is related to a vehicle coordinate system. Thus, by means of the parking space identification model 11, objects, such as free parking spaces, are located in the grid line network mapping the surroundings based on coordinates of grid cells.

From the output side, line of entry parameters EP and side boundary line parameters SP are output, which allow the location of the parking space relative to the vehicle to be described based on geometric parameters relative to the grid line network such that an automatic parking algorithm 12 based on this can easily perform a parking operation. The parking algorithm 12 accordingly determines, in a known manner, a parking trajectory S along which the vehicle 1 is to be moved into the parking space.

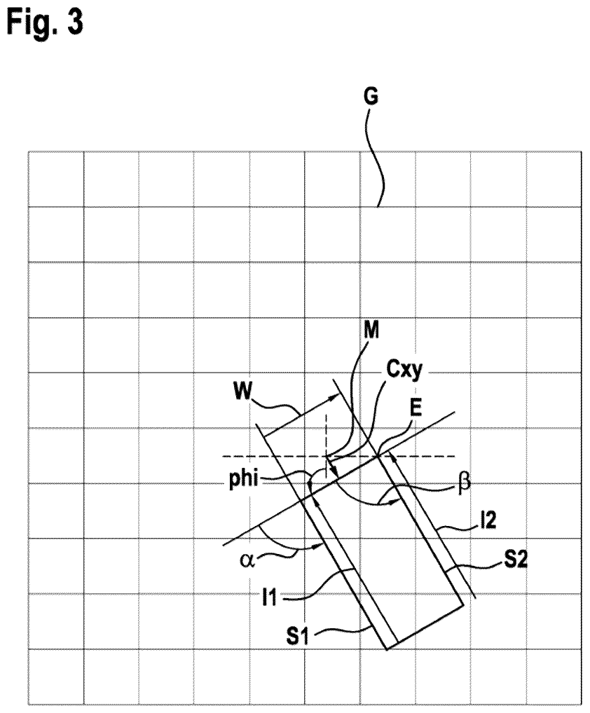

The representation of the parking space is carried out as described in connection with FIG. 3. The localization is not carried out as in prior art methods, by determining the vertices of a parking space, but by determining line of entry parameters describing a location and width of a line of entry into a free parking space. The line of entry parameters EP include a distance of a center point Cxy of the line of entry E from a center M of a grid cell of the grid line network G and the direction of this distance vector phi. Furthermore, the line of entry parameters EP include the width W of the line of entry E.

The side boundary line parameters SP determine the location of the side boundary lines S1, S2 depending on the location of the line of entry. The side boundary lines S1, S2 may extend from the end points of the line of entry E, with each being defined by a length L1, L2 as well as a side boundary line angle α, β. Thus, the parking space may be clearly defined even in the case of non-rectangular shapes.

Representation of the parking space by line of entry parameters EP and side boundary line parameters SP includes, in a direct and straightforward manner, usable characteristics of the parking space that may be further processed by the automatic parking algorithm 12.

In addition, representing the location of the parking space enables the use of a single-step parking space identification model 11 and the definition of a loss function for training the data-based parking space identification model 11 based on real parking space characteristics. The loss function represents a cost function for a conventional training algorithm of a data-based model.

Training of the parking space identification model 11 may be performed in a conventional manner based on known training methods such as back propagation using a predetermined loss function.

The loss function generally takes into account the deviation of a desired output of the parking space identification model 11 from an actual output. To weight the importance of the parking space characteristics with respect to a parking process, the loss function may rate the consideration of the line of entry parameters EP higher and may rate the side line parameters correspondingly lower. In addition, the loss function may easily account for a deviation of the side boundary line angles α and β in such a way that the greater the deviation between the side boundary line angles α and β, the greater the loss. Certain ranges of values that are common for the sideline angles α and β and the width W of the line of entry can also be defined, so that high loss proportions can be provided for when values deviate therefrom.

1-11. (canceled)

12. A method for identifying a parking space for a vehicle, comprising:
providing a camera image; and
evaluating the camera image using a data-based parking space identification model, the parking space identification model being designed to assign a camera image to a representation of a parking space in surroundings of the vehicle that are covered by the camera image, wherein the representation of the parking space indicates a position for a line of entry into the parking space in a vehicle coordinate system,
wherein the representation of the parking space is further indicated by side boundary lines, the location and orientation of which is defined based on the location of the line of entry, and
wherein representation of the parking space by an automatic parking algorithm is used to automatically control a parking operation of the vehicle by determining a parking trajectory.

13. The method according to claim 12, wherein the location of the line of entry is indicated as a distance vector between a center of the line of entry and a center of a grid cell in a grid line network.

14. The method according to claim 13, wherein the representation of the parking space further indicates a width of the line of entry.

15. The method according to claim 13, wherein the parking space identification model is configured with a neural network and has a YOLOv3 architecture that locates the parking spaces in the grid line network.

16. A computer-implemented method for training a data-based parking space identification model, comprising:
providing training data sets that each assign a camera image of captured vehicle surroundings to a representation of a parking space captured in the camera image, wherein the representation of the parking space indicates a position for a line of entry into the parking space and a location and orientation of side boundary lines connected to the line of entry, wherein the representation of the parking space is further indicated by the location and orientation of the side boundary lines; and
training the data-based parking space identification model using a loss function, wherein the loss function weights the location of the line of entry higher than the location and orientation.

17. The method according to claim 16, wherein the loss function further evaluates a difference between the side boundary line angles to the line of entry.

18. A device for performing the method according to claim 12.

19. A computer program product comprising commands which, when executed by at least one data processing device, cause the data processing device to perform the steps of the method according to claim 12.

20. A machine-readable storage medium comprising commands which, when executed by at least one data processing device, cause the data processing device to perform the steps of the method according to claim 12.

21. The method of claim 12, wherein the method is a computer-implemented method.

22. The method of claim 12, wherein the location and orientation of the side boundary line is defined by a length of the respective side boundary line and the side boundary line angle to the line of entry.

23. The method of claim 16, wherein the representation of the parking space is further indicated by a length of the respective side boundary line and the angle of the respective side boundary line to the line of entry.
